(19) United States
(12) Patent Application Publication
(10) Pub. No.: US 2004/0034626 A1
(43) Pub. Date: Feb. 19, 2004

(54) Browsing method and apparatus

(76) Inventors: Neil Peter Fillingham, Ferntree Gully (AU); Raymond Duncan Fillingham, Lysterfield (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/398,300

(22) PCT Filed: Oct. 1, 2001
(86) PCT No.: PCT/AU01/01222

(30) Foreign Application Priority Data
Oct. 31, 2000 (AU) PR1117

(51) Int. Cl. G06F 17/30

(52) U.S. Cl. 707/3

(57) ABSTRACT

Apparatus for browsing content (10) on a computer network comprising, a computer connectable to the computer network, browser means (16) executable on the computer for browsing said content, data storage means for storing a search filter (18, 22, 26) comprising search criteria, the filter maintainable by a user, wherein the computer is operable, independently of operations performed by the user when accessing said content, to apply the filter to the content, when the user accesses the content and to output results comprising a record of any content (38) identified by the filter as matching the search criteria.

### FIELD OF THE INVENTION

The present invention relates to a browsing method and apparatus for browsing content on a computer network such as the Internet, or a subset thereof such as the world wide web.

### BACKGROUND OF THE INVENTION

Existing browsing applications allow a user to identify information on a remote computer in several ways. A search term can be entered, which is then compared with an index of information (found, for example, in web sites) prepared by a search engine. Alternatively, the user can enter the URL of a web site, thereby directing the browser to establish a connection with that site and copy information found at the site. Further, the URLs of sites or individual pages previously inspected by the user may be stored in a list maintained by the browser as a record of browser activity. The user may also maintain a list of “favourites” or “bookmarked” resources.

These techniques, however, commonly identify or save the URLs of either too many sites or too few: at one extreme, all possible sites (either pertaining to a search term or as visited by the user) are recorded, which will include many sites of relatively little interest to the user. At the other extreme, the user saves only sites or resources of interest if manually inspected and flagged as such by adding the site or resource to a list of “favourites” or “bookmarked” resources.

It is an object of the present invention to provide a method and apparatus for identifying the location of information of possible interest to a user while that user is browsing a computer network.

### SUMMARY OF THE INVENTION

The present invention provides, therefore, an apparatus for browsing content on a computer network, comprising,

a computer connectable to said computer network,

browser means executable on said computer for browsing said content,

data storage means for storing a search filter comprising search criteria, the filter maintainable by a user,

wherein said computer is operable, independently of operations performed by the user when accessing said content to apply the filter to the content when the user accesses the content, and to output results comprising a record of any content identified by the filter as matching the search criteria.

Preferably said results include the address of any content matching said search criteria, a copy of at least a portion of any content matching said search criteria, or both.

Thus, while the user browsers the network, such as the Internet, the computer checks each accessed piece of content (such as a web page) and preferably notes where that content was found. The user can thereby conduct a search for material of interest (specified by the search strings) while browsing, even for material on an apparently unrelated topic. The apparatus in doing so might be said to watch over the user's shoulder while he or she surfs the Internet and to take notes of any items the user has previously identified in the search string file as being of interest.

Although primarily intended and designed for use on the Internet, the apparatus (and method described below) can also be applied to any data stream or data source.

The apparatus may include limiting means for preventing recordal of content in excess of predetermined amount of said content set by the user. Preferably said apparatus is operable to additionally apply said filter to linked content linked to said content and, more preferably the depth of links so resolved by said apparatus is controllable by said user. Thus, the apparatus can drill down to a default depth (which might comprise resolving only a single link), or to a depth selected by the user.

Preferably said filter includes one or more search strings, and more preferably a plurality of search strings and one or more logical rules defining one or more relationships between each of said plurality of search strings.

Preferably said relationships include Boolean operators.

Thus, the user can configure the apparatus to search, for example, for string A and string B, string A or string B, string A but not string B, string A near string B, string A and (string B or string C), string A and stringB and string C, etc.

Preferably said apparatus is operable to include in said results at least the address of any content matching said search criteria, subsequently to inspect said content matching said search criteria for any alterations, and to output a revised record, or notify said user, of content so altered, whereby said results includes sufficient information for said apparatus to identify the occurrence, and hence nature, of said alterations. More preferably said apparatus is operable to output said revised record, or notify said user, of content so altered, only if said content so altered still matches said search criteria on the basis of which said content was first identified.

Thus, the apparatus—in this mode—can visit, for example, sites automatically and locate items previously identified to be of interest and since updated.

Preferably said apparatus is operable subsequently to inspect said content matching said search criteria for any alterations at predefined tines, such as predefined times of the day, days of the week or dates.

The apparatus may include means to limit the recordal of content in excess of a predetermined amount. The predetermined amount may be expressed in bytes or items identified by the filter.

The present invention also provides a method for browsing content on a computer network, comprising,

storing a search filter including search criteria,

browsing said content by means of a computer,

applying said filter to said content when a user accesses said content independently of operations performed by the user when accessing said content, and

outputting results comprising a record of any content identified by said filter as matching said search criteria.

Preferably said method includes identifyng in said record the address of any content matching said search criteria, and may include a copy of at least a portion of any content matching said search criteria, or both.

Preferably said method includes additionally applying said filter to linked content linked to said content and, more preferably specifying the depth of links so resolved.

Preferably said filter includes one or more search strings, and more preferably a plurality of search strings and one or more logical rules defining one or more relationships between each of said plurality of search strings.

Preferably said method includes:

including in said results at least the address of any content matching said search criteria,

on a subsequent accession inspecting said content matching said search criteria for any alterations, and

outputting a revised record, or notifying said user, of content so altered,

whereby said results includes sufficient information for the occurrence of said alterations to be identified.

More preferably the method includes:

outputting said record, or notifying said user, of content so altered, only if said content so altered still matches said search criteria on the basis of which said content was first identified.

Preferably said method includes subsequently inspecting said content matching said search criteria for any alterations at predefined times, such as predefined times of the day, days of the week or dates.

The present invention also provides a computer provided with or running a computer program encoding the method for browsing content on a computer network as described above.

The present invention still further provides a computer readable storage medium provided with a computer program embodying the method for browsing content on a computer network as described above.

In order that the present invention may be more readily ascertained, preferred embodiments will now be described, by way of example, with reference to the accompanying drawings, in which:

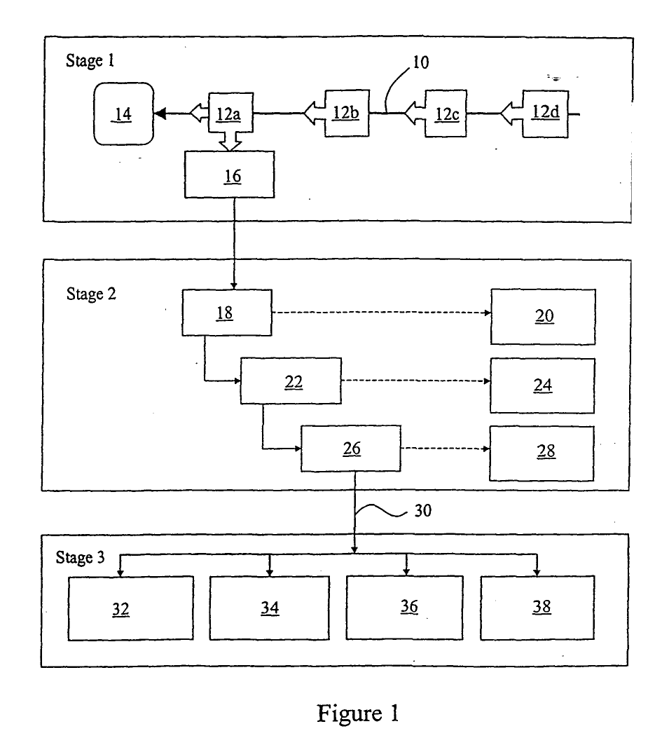

FIG. 1 is a schematic representation of an information gathering and organizing tool according to a preferred embodiment of the present invention;

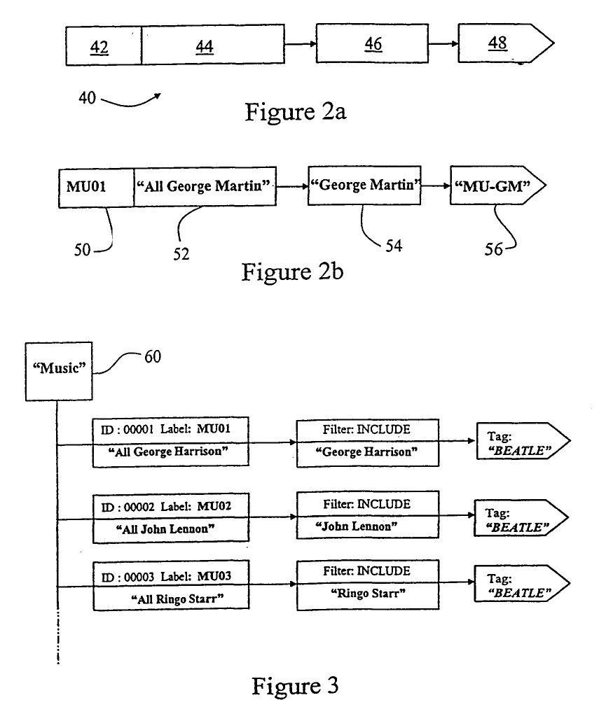

FIG. 2a is a schematic representation of a minimum Thread construct of the tool of FIG. 1;

FIG. 2b is a schematic representation of an example of a simple thread of the type shown in FIG. 2a;

FIG. 3 is a schematic representation of a simple snoop list of the tool of FIG. 1;

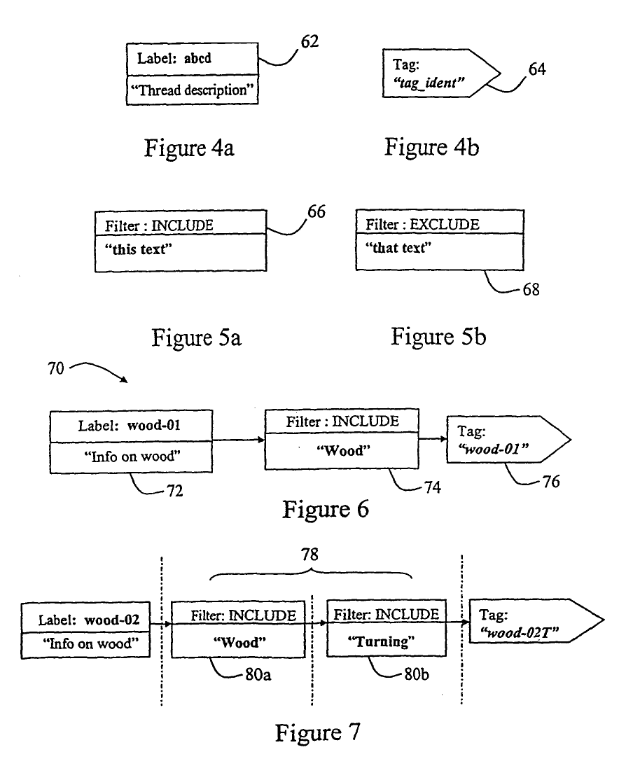

FIG. 4a is a schematic representation of a THREAD LABLE of the tool of FIG. 1;

FIG. 4b is a schematic representation of an ACTION TAG of the tool of FIG. 1;

FIG. 5a is a schematic representation of an INCLUDE filter of the tool of figure;

FIG. 5b is a schematic representation of an EXCLUDE filter of the tool of figure;

FIG. 6 is a schematic representation of the simplest practical Thread of the tool of FIG. 1;

FIG. 7 is a schematic representation of an “AND” construct of the tool of FIG. 1;

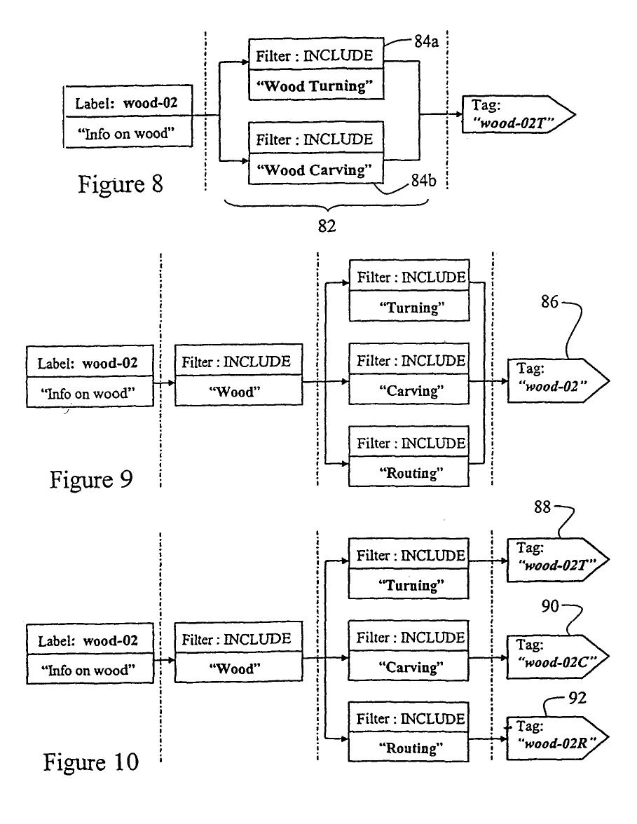

FIG. 8 is a schematic representation of an “OR” construct of the tool of FIG. 1;

FIG. 9 is a schematic representation of a combination of “AND” and “OR” constructs according to the embodiment of FIG. 1;

FIG. 10 is a schematic representation of a Thread split to produce a plurality of branches each with its own termination Tag according to the embodiment of FIG. 1;

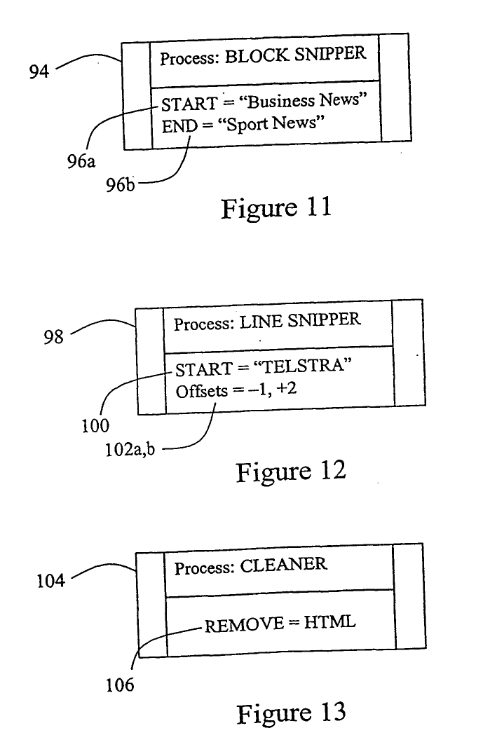

FIG. 11 is a schematic representation of an example of the BLOCK SNIPPER process of the tool of FIG. 1;

FIG. 12 is a schematic representation of an example of the LINE SNIPPER process of the tool of FIG. 1;

FIG. 13 is a schematic representation of an example of the CLEANER process of the tool of FIG. 1;

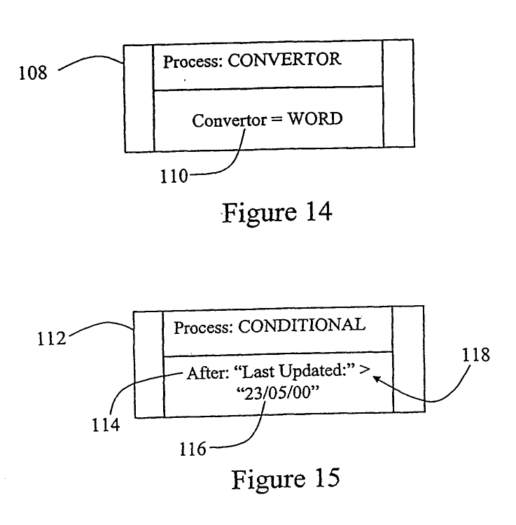

FIG. 14 is a schematic representation of an example of the CONVERTOR process of the tool of FIG. 1; and

FIG. 15 is a schematic representation of an example of the CONDITIONAL process of the tool of FIG. 1.

An information gathering and organizing tool according to a preferred embodiment of the present invention is described below. The principal purpose of the tool is to provide a quick way of noting internet URLs pertaining to data files of specific interest and, if required, to organize the textual information extracted into a database that can be accessed off-line by the user.

The tool includes two modes, termed “snoop mode” and “ferret mode”.

In snoop mode, the tool scans web pages accessed by the user and compares the content of the pages with a previously created list (the “snoop list”) of search strings in the form of keywords. The tool may in fact have access to a number of separate such snoop lists, separately selectable by the user.

As the user browsers the internet and accesses web pages, the tool scans them against the previously selected snoop list to ascertain if there is any information on the page that is of interest to the user.

A snoop list contains one or more “Threads”. Each Thread consists of a number of filters and other processing blocks that are arranged to produce AND/OR/INCLUDE/EXCLUDE selection criteria to identify information of interest to the user.

Web pages are therefore tested against the thread filters and provided matching criteria are satisfied the Web page will trigger an Action Tag attached to the end of the Thread.

The actions triggered by a Web page passing through a Thread will depend upon user selected options. Possible triggered actions include:

The address of the web page is noted (default);

A visual or audible alert is created;

The whole web page text (or part of it) is noted;

An e-mail message is generated; or

All of the above can be automatic or can query the user if the selected action is to occur.

Thus, at the minimum, the tool creates a database of Web Page addresses attached to a Thread Tag. At the other extreme, the tool creates a complete database containing the full web pages again accessed via the Thread Tag.

Any new entries on a Thread can be flagged as “Unread”; the tool allows-the user to view new entries when desired.

The tool also allows the user, when on a selected Web Page, to control or set the tool to automatically find any linked pages on the current Web page and to load and scan them all (i.e. “Drill Down”).

If an initial web page is considered to be at level 1, any pages linked to that page as level 2 and any linked to them as level 3, etc., the level of drilling down can be preset to restrict the tool to “n” levels or it can be set to drill down to “All” levels.

“Ferret mode” is similar to drilling down except that it works from a predefined list of web site addresses, automatically visiting each site and drilling down as required by the user.

The list of sites to be visited is created from the Thread database created within Snoop Mode. Any matches then trigger a similar set of actions to a match in Snoop mode.

Ferret mode can be set to automatically trigger at predefined times, dates or days.

The tool can be built into (that is, be an integral part of) a web browser-or may be a separate process positioned either in front or behind the browser. The tool can also be implemented as a network version, and sit at the level of the Proxy Server and scan all web pages accessed by all users. This allows large organizations (such as businesses, health institutions or academic institutions) to create Snoop databases containing data of common interest. For example, doctors, nurses and other users at a hospital might access the Internet for information of specific interest to themselves; the tool can be used to scan the pages and build a database with information of common interest, such as for a research project.

Optionally, the tool can allow users to:

select text to be extracted;

extract pictures and sound from sites (by means of appropriate descriptors);

extract paragraphs;

email other users when matches occur; and

share office user snoop lists in the network version.

Process Flow and Modules

The tool is illustrated schematically in FIG. 1, and is represented divided into three stages: Stage 1, in which data items are obtained, stage 2, in which unwanted data items are removed, and stage 3, in which action triggers are tagged.

The primary target for the tool is the Internet and consequently the primary data items being processed are web pages. However, the tool is not restricted to processing Internet web pages. The source of data can be any data stream or a partial extract from a data stream. In the present description, therefore, the terms “Page” or “Web Page” are used when referring to the source data stream and “Item” or “Data Item” where data is being processed, but should not be regarded as restricting the application of the tool to web pages.

Thus, FIG. 1 illustrates a typical data stream 10 comprising first web page 12a, second web page 12b, third web page 12c, etc. In a standard browsing session, these are downloaded by and presented for inspection to a user 14.

The tool includes an extractor module 16, which obtains a page of information from the data stream 10 either before, or after, a page 12a,b,c,d has been so presented to the user. If necessary, the extractor 16 queues the pages 12a,b,c,d for subsequent processing.

The extractor 16 may be part of a web browser, part of a proxy server, a separate stand alone process or built into an Internet ISP sites software. Thus, it can be located to intercept the data stream at any point.

In stage 2, the tool includes an address eliminator 18, which checks the origin address of each page 12a,b,c,d (i.e. its respective web site address) against an “Exclude List” previously noted by the user not to be of interest. A page whose site address is found in the Exclude List are discarded 20. The Exclude List can be augmented when the user when a site is identified by the tool but proves not to be of interest or is a “false hit”. Other examples of where address exclusion may be required are include “Search” sites (e.g. Yahoo brand and Excite brand web sites) which will almost certainly trigger unwanted hits, or sites that are known to contain unreliable data.

In addition, or alternatively, the address eliminator 18 can check the origin site address against a list of addresses that are the only sites of interest (i.e. an “Include List”). Address inclusion might be required, for example, by a university student who is interested only in sites acknowledged to be reliable (e.g. Research Laboratories, other academic sites or governmental authorities).

The tool reads the currently selected snoop list 22 (comprising a collection of Threads), and discards items not of interest 24. A Thread is a named definition of a route through a series of checkpoints (i.e. text filters) arranged to pass only desired data items to a specific Action Tag. Any data item that traverses a route through a Thread to an Action Tag will trigger one or more actions.

Threads consist of levels of filters, and processing blocks, arranged in AND, OR, EXCLUDE combinations that route required data items to termination Tags.

At any point the currently selected snoop list 22 is parsed against data items received within the active session and each item is tested against all Threads within the open snoop list 22.

The primary purpose of a Thread is to ensure that only the required data items reach an Action Tag however other processes within the Thread can be used to manipulate the data text (i.e. extract a part of it or convert the format) prior to actions being taken with it. A Thread can be defined or expressed in plain text, program language or GUI format.

A Thread always contains at least one Action Tag. There can be more than one Tag attached to a single Thread but parsing of a Thread that has no Tag would be pointless and is therefore invalid. Snoop lists and Threads are discussed in greater detail below.

The tool then includes a Double Entry Checker 26, which ensures that a data item, emerging from a Thread, is not duplicated within the database and does not trigger any further Tag Actions (i.e. bell, email, print item, etc). Duplicates are discarded 28.

Non-discarded items are then passed 30 for further processing in stage 3. The origin address of each such data item is saved 32 in a database and a Sum Check generated and noted against it. All subsequent data items are then first checked against any existing addresses and then the sum check is compared against those held in the database.

A Tag is a termination element within a Thread. Normally it will be the last element but can be located at other points within a thread. A Tag provides an Action point Trigger (i.e. a point is reached where actions have to be taken). Most of these actions are optional and may be combined.

Typical actions are:

Note Address Information 32 (default and mandatory: discussed above); the Data Items origin address (e.g. its origin web page address) is noted 32 as an indexed entry within a database. Alternatively the address may simply be added to a list of addresses held in a flat file whose name is identified in the Threads Termination Tag. Immediately Alert the User 34 (optional); this may take the form of: sounding a warning bell, displaying an Icon or Button that needs to be closed to remove it, or displaying a “pop up” Window that needs to be closed to remove it Send an email 36 (optional); trigger one, or more, email messages to notify recipients of new entries, or modifications, that have been made in the database. Enter Item into a Database 38 (optional); all, or a selected part, of the Data Item that passed through the Thread can be entered into a database. In this context, the database may simply be a set of files held at a specific location or may be a fully indexed, or otherwise referenced, database (e.g. an ODBC database)

Snoop Lists and Threads

As mentioned previously, the primary purpose of a Thread is to ensure that only those data items identified as being required reach an Action Tag point. A Thread can be defined or expressed in plain text, program language or GUI format. In the following description, however, and solely for the sake or clarity, only the GUI format will be used.

A Thread consists of a route map through a series of checkpoints (or filters) that accept or eliminate data items. Each Thread has a unique ID, a “Label”, to identify it and an associated descriptive text to allow clear identification of its purpose.

The Thread ID is a unique number and assigned automatically when the Thread is first created. The ID will not normally be displayed.

The Label does not have to be unique: it may be any combination of alphanumeric characters and is used primarily for sorting the order of presentation when displaying a snoop list.

A Thread must have at least one Action Tag, to trigger processing of data items that pass through the Thread, and at least one filter block.

A minimum Thread construct 40 according to this preferred embodiment is shown, by way of example, in FIG. 2a The Thread 40 includes Label 42, Description 44, Filter 46 and Tag 48.

An example of a simple thread is shown in FIG. 2b. In this example, the Thread has the Label 50 “MU01” and the Description 52 “All George Martin”. All web pages will be checked by Filter 54 for the text “George Martin” and any matching items will be actioned according to the options defined in Action Tag 56 “MU-GM”. At a minimum a database of all addresses for sites containing the text “George Martin” will be created against the MU-GM tag 56.

The Action Tag 56 will default to the ID if nothing else is defined but, while IDs have to be unique, the associated Action Tag identifiers do not. Hence, more than one Thread may terminate with the same Action Tag.

FIG. 3 illustrates a simple snoop list 60 (entitled “MUSIC”), which will parse for any occurrences of “George Harrison”, “John Lennon” or “Ringo Starr” and, at a minimum, create a database attached to the Tag “BEATLE” of site addresses that contain information on the Beatles.

However, the snoop list 60 of FIG. 3 is not well designed in that name matches with individuals who were not part of the Beatles would occur.

Basic Components of a Thread

As discussed above, a Thread consists of a route map through a series of checkpoints (or filters) that accept or eliminate data items. The majority of applications will not need much more than the following basic component blocks:

THREAD LABLE

ACTION TAGS

INCLUDE Filter

EXCLUDE Filter

A more complete list of possible Labels, Tags Filters, Processing and Conditional blocks, along with their associated properties, is given below in the Appendix.

FIG. 4a illustrates a THREAD LABLE 62 of the tool of this embodiment. The LABLE 62 provides a unique D, a grouping code and a description as a mechanism for identifying a Thread and its purpose. It is the Start of a Thread.

A label does not do any processing itself other than to activate the route through the Thread.

FIG. 4b illustrates an ACTION TAG 64 of the tool of this embodiment. The TAG 64 terminates a particular route through a Thread. Its properties provide a list of actions that will occur should a Page or Data Item reach that point in the Thread. Some possible properties (i.e. actions) have been discussed above; the following is a more complete list:.

Note Address Information (see above);

Immediately Alert the User (see above);

Send an e-mail (see above);

Request a specific site (optional); automatically send a request for a specific web page to be loaded;

Enter Item into a Database (see above).

The two basic forms of filter of the tool of this embodiment, the INCLUDE filter 66 and the EXCLUDE filter 68, are illustrated in FIGS. 5a and 5b respectively. These two filters are the primary building blocks of a Thread and central to the core activities of the tool.

These filters are intended to allow a page to pass onto to the next stage within the Thread on the basis that the page includes (INCLUDE filter 66), or does not include (EXCLUDE filter 68) a specific sequence of text.

With both types of filter, variations in the actions taken by the filters can be achieved via a number of properties that allow additional fuictionality to be turned ON/OFF as required (discussed in further detail in the Appendix).

The INCLUDE filter 66 identifies a sequence of text that must be present anywhere within in a Page if it is to pass that point in the Thread. Hence, with the INCLUDE filter 66 of FIG. 5a, only pages containing “this text” will proceed to the next stage in the Thread.

The EXCLUDE filter 68 identifies a sequence of text that must not be present anywhere within a Page if it is to pass that point in the Thread. Hence, with the EXCLUDE filter 68 of FIG. 5b, any pages containing “that text” will not proceed to the next stage in the Thread.

Assembling a Thread

As discussed above, a Thread starts with a LABEL and ends with a TAG but between these two components any combination of filters and/or processing blocks may be arranged to eliminate unwanted data.

The simplest possible Thread would be a LABLE and TAG, but such an arrangement would pass every page through to the TAG and in effect create an history of all sites and pages visited (i.e. a duplicate of a browser's “History” option).

Referring to FIG. 6, the simplest practical Thread 70 of the tool of this embodiment comprises a LABLE 72, a FILTER 74 and a TAG 76. Thread 70 provides a simple mechanism for capturing any information about “Wood”, but would also pick up a lot of unwanted information such as articles written by authors with the surname “Wood”.

If the user is only interested in articles on “Wood Turning”, a more precise set of information that only contains the words “Wood” and “Turning” can be located by arranging two filters in series (i.e. a page must pass through both filters), by means of the “AND” construct

FIG. 7 illustrates an “AND” construct, comprising a combination 78 of filters 80a and 80b; in this example, any page that passes through to the Tag must contain both “Wood” AND “Turning”.

If the same user is actually interested in articles on “Wood Turning” or “Wood Carving” then by arranging two filters in parallel a page will reach the Tag if it contains either of the matching text items.

FIG. 8 illustrates a combination 82 of filters 84a and 84b that is known as an “OR” construct, since any page that passes through to the Tag must contain “Wood Turning” OR “Wood Carving”.

By combining the “AND” and “OR” constructs Threads can be created with varying degrees of complexity and any number of stages of processing. In the example shown in FIG. 9, any pages containing:

“Wood” AND (“Turning” OR “Carving” OR “Routing”) will be passed to the Tag 86 “wood-02”.

A Thread can be split to produce branches and each branch can have its own termination Tag. Thus, in the example shown in FIG. 10, any pages containing “Wood” AND Turning” will be passed to Tag 88 “wood-02T”, containing “Wood” AND Carving” will be passed to Tag 90 “Wood-02C”, and containing “Wood” AND Routing” will be passed to Tag 92 “wood-02R”.

### APPENDIX—FILTERS, PROCESSING AND CONDITIONAL BLOCKS

Other than “Labels” and “Tags”, there are several types of component blocks that can be combined to create a complete Thread according to the present invention. These are:

Filters, which provide a mechanism to accept or reject a page;

Processing blocks, which modify the page text in some fashion; and

Conditional blocks, which provide specific focussed actions.

Filters have been discussed in general terms above. In addition, INCLUDE filters have the following properties:

Text: the text that must be present within the page;

Case: flag indicating “Case Sensitive” or not;

Whole: flag indicating that only “Whole text” matches are allowed; and

Plural: flag indicating whether plurals are allowed or not.

EXCLUDE filters have the following properties:

Text: the text that must not be present within the page.

Case: flag indicating “Case Sensitive” or not.

Whole: flag indicating that only “Whole text” matches are allowed

Plural: flag indicating whether plurals are allowed or not.

A Processing Block modifies the Page in some manner before passing it on to the next stage in the Thread.

A number of Processing Blocks according to the present invention are described below by way of example, in order to show the type of functionality provided by this type of device. Further possible Processing Blocks within the scope of the invention will be apparent to those in the art.

FIG. 11 illustrates schematically an example of the BLOCK SNIPPER process 94 of the tool of this embodiment. The BLOCK SNIPPER process 94 extracts part of a Page based on defined “Start” and “End” text sequences 96a and 96b (reading, in this example, “Business News” and “Sport News” respectively). Its purpose is either to focus subsequent processing onto a section of a page or to allow a focussed selection of data for saving into the database.

The BLOCK SNIPPER process 94 operates by searching the Page for the START sequence of text 96a, then the END sequence of text 96b and removes all text outside these two points, that is, the process 94 only passes on the text between START and END sequences.

If the START sequence 96a is not found but the END sequence 96b is, then all text from the start of the Page up to the END sequence 96b is passed on. If the END sequence 96b is not found but the START sequence 96a is, then all text from the START sequence 96a on the Page up to the end of the Page is passed on.

If neither the START sequence 96a or END sequence 96b is found then nothing is passed on and that path through the Thread is terminated.

Hence, in the example shown in FIG. 11, all text between “business News” and “Sport News” will be passed on to the next stage in the Thread. The text outside of this will be discarded.

The BLOCK SNIPPER process 94 and its components have the following properties:

Start Text 96a: the text identifying the “start text sequence” and having the properties:

Case: flag indicating “Case Sensitive” or not;

Whole: flag indicating that only “Whole texf”matches are allowed;

Plural: flag indicating whether plurals are allowed or not;

Offset: number of lines before(−) or after(+) to start extracting at.

End Text 96b: the text identifying the “end text sequence” and having the properties:

Case: flag indicating “Case Sensitive” or not;

Whole: flag indicating that only “Whole text” matches are allowed;

Plural: flag indicating whether plurals are allowed or not;

Offset: number of lines before(−) or after(+) to stop extracting.

FIG. 12 illustrates schematically an example of the LNE SNIPPER process 98, which extracts part of a Page based on a defined “Start” text sequence 100 and defined offsets 100a,b defining a number of lines either side of that point. Its purpose is either to focus subsequent processing onto a section of a page or to allow a focussed selection of data for saving into the database.

The LINE SNIPPER process 98 searches the Page for the line containing the START sequence of text 100 and then removes all prior lines and all subsequent lines outside of the offsets 100a,b indicated. If the START sequence 100 is not found then nothing is passed on and that path through the Thread is terminated.

In the illustrated example, the START sequence 10a is “TELSTRA” and the offsets 100a,b are −1,+2, so the line before and the two lines after the first line found containing the text “TELSTRA” will be passed on to the next stage in the Thread. The text outside of this will be discarded.

The LINE SNIPPER process 98 and its components have the properties:

Start Text 100: the text identifying the “start text sequence” and having the properties:

Case: flag indicating “Case Sensitive” or not;

Whole: flag indicating that only “Whole text” matches are allowed;

Plural: flag indicating whether plurals are allowed or not.

Offset1 102a: number of lines before(−) or after(+) to start extracting at.

Offset2 102b: number of lines before(−) or after(+) to stop extracting.

FIG. 13 illustrates schematically an example of the CLEANER process 104, which removes or cleans out specific characters or formatting type information before passing the Page on to the next stage in the Thread. The type information to be removed is indicated by a Cleaner property 106. Hence, in the illustrated example, all HTML command sequences will be removed before passing the Page on to the next stage.

The CLEANER process 104 has the following properties:

Cleaner: type of cleaner required (i.e. “HTML”, “ASCII” or “TEXT”);

Chars: a list of chars to be removed; only used when the Cleaner=“CHARS”.

Some examples of the CLEANER process 104 include:

Cleaner=“HTML” then all HTML control sequences are removed;

Cleaner=“ASCII” then all NON ASCII (i.e. other than “A-z” and the space character) are removed;

Cleaner=“TEXT” then all CRs are removed except those following a period;

Cleaner=“CHARS” then all characters contained in Chars are removed.

FIG. 14 illustrates schematically an example of the CONVERTOR process 108 of the tool, which is intended for where the end document needs to be in a specified format, such as suitable for loading into a word processor application or into a spreadsheet. Thus, in the illustrated example, the CONVERTOR process 108 has the Convertor property 110 “WORD”, so that output data pages will be output in a format that is readable by Word brand word processors.

The CONVERTOR process 108 has the following properties:

Convertor: conversion required “WORD”, “CSV”, “WP”, etc;

Version: version number of the target application.

A Conditional Block allows specific sections of the page to be selected and tested against conditional criteria As with the INCLUDE/EXCLUDE filters, if the conditions checked for create a match situation then the data item will be allowed to pass, otherwise it will be discarded.

One significant difference with these types of block is that they can dynamically save a value for testing against on a subsequent processing occasion.

In the example Processing Block shown below is intended only to show the type of functionality provided by this type of device. It is expected that a number of variations will be required later in the development of this product.

FIG. 15 illustrates schematically an example of the CONDITIONAL process 112, which locates a specific string of text and then locates a date item within a specified offset 114 from the text and tests it against a $VALUE variable 116 according to a condition 118.

The $VALUE variable may be a literal value (e.g. “27.4”, “15/03/2000” or “123”) or be a note of the last value that triggered this block.

Hence, in the illustrated example, the first date format item found after the string “Last Updated:” has been located will be tested against the “23/05/00” and will trigger if a date later than that is detected.

The CONDITIONAL process 112 has the following Properties:

Start Text: the text identifying the “Identification text sequence”;

Case: flag indicating “Case Sensitive” or not;

Whole: flag indicating that only “Whole text” matches are allowed;

Plural: flag indicating whether plurals are allowed or not;

Condition: how to test (e.g. “>”, “<”, “>=”, “<=”, “><” or “=”);

Value Type: Date, Number, Integer, Currency, Text;

Offset Type: Next date(+n), Next number (+n), Next integer (+n), Next Currency(+n);

Value: the actual value to test against.

In one example using CONDITIONAL blocks, a specific web page contains a list of company ASX (Australian Stock Exchange) codes and their share prices. The format of the page is consistent: the Gain/Loss is always after two other currency columns on each row.

Thus, in this example, a web page format contains data of the type shown in table 1.

| ASX | Last | High | Low | Bid | Ask | Close | BVal | PVal | G/L |
|---|---|---|---|---|---|---|---|---|---|
| CBA | 23.66 | 23.7 | 23.3 | 23.65 | 23.66 | 23.4 | $13830 | $14196 | $366 |
| NAB | 23.03 | 39.2 | 22.97 | 23.03 | 23.05 | 23.05 | $2400 | $2520 | $120 |
| TLS | 8.13 | 8.15 | 8.03 | 8.13 | 8.14 | 8.04 | $4125 | $4065 | −$60 |
| WOW | 5.4 | 5.5 | 5.4 | 5.4 | 5.41 | 5.5 | $372 | $3240 | −$132 |

Then, having previously eliminated other web pages, based on the web address, a CONDITIONAL block can be used to trigger actions based on when “TLS” stock has a loss of more than $50 by setting properties along the lines of:

| Start Text | “TLS” |
|---|---|
| Case Sensitive“ | Y” |
| Whole Words | “Y” |
| Plural Allowed | “N” |
| Condition | “<” |
| Value Type | Currency |
| Offset Type | Next Currency(+2) |
| Value | “−$50” |

In this example, the CONDITIONAL block would locate “TLS”, find the 1st currency column (“Bval”), then the next (i.e. +1, hence the “Pval”) and finally the next (i.e. +2, hence the “G/L” column) and test the value found there for being “<−$50”. The block would then trigger and subsequent Tag Actions occur. A separate CONDITIONAL block Thread would be needed for each additional row that the user wishes to test (such as “CBA” or “WOW”).

It is to be understood that the word comprising as used throughout the specification is to be interpreted in its inclusive form ie. use of the word comprising does not exclude the addition of other elements.

Modifications within the spirit and scope of the invention may readily be effected by persons skilled in the art. It is to be understood, therefore, that this invention is not limited to the particular embodiments described by way of example hereinabove.

1. Apparatus for browsing content on a computer network comprising,
a computer connectable to the computer network,
browser means executable on the computer for browsing said content,
data storage means for storing a search filter comprising search criteria, the filter maintainable by a user,
wherein the computer is operable, independently of operations performed by the user when accessing said content, to apply the filter to the content, when the user accesses the content and to output results comprising a record of any content identified by the filter as matching the search criteria.

2. Apparatus according to claim 1 wherein the computer is operable to apply the filter to content on a plurality of web sites on the Internet accessed by the user and to compile an output of results of any content identified by the filter as matching the search criteria from the plurality of web sites accessed by the user.

3. Apparatus according to claim 1 including limiting means for preventing recordal of content in excess of a predetermined amount of said content said limiting means being capable of being set by the user.

4. Apparatus according to claim 3 wherein the predetermined amount of said content is expressed in at least one of bytes and items identified by the filter as matching the search criteria.

5. Apparatus according to claim 2 wherein the filter includes a plurality of search strings and there are logical rules defining relationships between each of the plurality of search strings.

6. Apparatus according to claim 5 wherein the relationships include Boolean operators.

7. Apparatus according to claim 1 wherein the apparatus is operable to additionally apply the filter to linked content linked to said content and the depth of the links is controllable by the user.

8. Apparatus according to claim 1 wherein the filter is set to include at least one of the address of any content matching the search criteria and a copy of at least a portion of any content matching the search criteria.

9. Apparatus according to claim 8 operable to include in said results at least the address of any content matching said search criteria, on a subsequent accession to the computer network, to inspect said content matching said search criteria for any alternations and to subsequently output a revised record or notification to the user of altered content whereby the subsequent output includes sufficient information for the apparatus to identify the nature of the alterations.

10. Apparatus according to claim 9 operable to subsequently output at least one of the revised record or a notification to the user of altered content only if the altered content still matches the search criteria on the basis of which the content was first identified.

11. Apparatus according to claim 9 operable to periodically inspect content matching the search criteria at addresses previously included in the record.

12. A method for browsing content on a computer network, comprising,
storing a search filter including search criteria,
browsing said content by means of a computer,
applying said filter to said content when a user accesses said content independently of operations performed by the user when accessing said content, and
outputting results comprising a record of any content identified by said filter as matching said search criteria.

13. The method of claim 12, comprising identifying in said record the address of any content matching said search criteria, or a copy of at least a portion of any content matching said search criteria, or both.

14. A method according to claim 13 including additionally applying said filter to linked content linked to said content and, specifying the depth of links so linked.

15. A method according to claim 12 wherein the filter includes a plurality of search strings and one or more logical rules defining one or more relationships between each of said plurality of search strings.

16. A method according to claim 12 comprising,
including in said results at least the address of any content matching said search criteria,
on a subsequent accession inspecting, said content matching said search criteria for any alterations, and
outputting a revised record, or notifying said user, of content so altered,
whereby said results include sufficient information for the occurrence of said alterations to be identified.

17. A method according to claim 16 including outputting said record, or notifying said user, of content so altered, only if said content so altered still matches said search criteria on the basis of which said content was first identified.

18. A method according to claim 17 including subsequently inspecting said content matching said search criteria for any alterations periodically.

19. A method according to claim 12 wherein the search filter forms part of a thread, the thread including a thread label for identifying the nature of the search filter and an action tag for triggering an action by the computer or computer network when the search filter identifies content matching the search criteria.

20. A method according to claim 19 wherein the thread includes at least one of an include filter and an exclude filter.

21. A method according to claim 19 wherein the action tag triggers at least one of:-
(i) entering at least one of address information and content matching said search criteria into a database;
(ii) sending an email;
(iii) alerting the user, and
(iv) automatically sending a signal for a specific web site to be loaded.

22. A method according to sub paragraph (i) of claim 21 wherein the action tag is recorded as part of an index for accessing content associated with the index.

23. A computer provided with or running a computer program encoding the method for browsing content on a computer network as defined in claim 12.

24. A computer readable storage medium provided with a computer program embodying the method for browsing content on a computer network defined in claim 12.
